(19) United States
(12) Patent Application Publication
(10) Pub. No.: US 2017/0185012 A1
(43) Pub. Date: Jun. 29, 2017

(54) IMAGE FORMING APPARATUS

(71) Applicant: CANON KABUSHIKI KAISHA, Tokyo (JP)

(72) Inventors: Masahiro Tsujibayashi, Nagareyama-shi (JP); Satoru Yamamoto, Noda-shi (JP); Katsuya Nakama, Nagareyama-shi (JP); Yasuharu Chiyoda, Nagareyama-shi (JP); Nobuhiro Kikuchi, Moriya-shi (JP)

(21) Appl. No.: 15/386,104

(22) Filed: Dec. 21, 2016

(30) Foreign Application Priority Data
Dec. 24, 2015 (JP) 2015-252519

(51) Int. Cl. G03G 15/20

(52) U.S. Cl. CPC G03G 15/2025

(57) ABSTRACT

An image forming apparatus includes an image forming portion, a fixing portion including a rotatable member and an information storing portion, an information acquiring portion, and a controller configured to control whether or not a cleaning process for removing a deposited matter on a surface of the rotatable member is executed depending on an elapsed time from a fixing portion demounting time indicated by information acquired by the information acquiring portion. When the elapsed time is not less than a predetermined time, the controller executes the cleaning process in a period from the mounting of the fixing portion to a start of fixing, and when the elapsed time is less than the predetermined time, the controller does not executes the cleaning process in the period.

### FIELD OF THE INVENTION AND RELATED ART

The present invention relates to an image forming apparatus of an electrophotographic type.

The image forming apparatus of the electrophotographic type includes a fixing device (fixing portion) for fixing an unfixed toner image, formed on a recording material, on the recording material. In order to obtain a high-quality product, a method in which devices for different purposes of use are replaced and used depending on a size or a kind of the recording material on which the image is fixed has been known. In Japanese Laid-Open Patent Application (JP-A) 2008-58365, in this method, in the case where a fixing device not meeting the recording material intended to be subjected to image formation is mounted, a constitution in which a message for prompting a user to replace the fixing device is disclosed.

In the case where a plurality of fixing devices usable in a single image forming apparatus are prepared and either one of the fixing devices is mounted and used in the image forming apparatus as in JP-A 58365, the fixing device which is not mounted in the image forming apparatus is temporarily stored outside the image forming apparatus by the user. In this case, depending on a storage environment of the user, there is a liability that dust (e.g., dirt such as waste textile) is deposited on a surface of a fixing member (rotatable member) in the fixing device. When fixing (fixing process) is carried out using the fixing device in a state in which the dust is deposited, there is a liability that the dust is deposited on the image on the recording material with the fixing (process).

Therefore, in the case where such a fixing device is mounted, it is required that the fixing member is cleaned, but when a constitution in which the cleaning is carried out every time when the fixing device is mounted is employed, there is a liability that it leads to useless electric power consumption with the cleaning. For example, in the case where a method of carrying out the cleaning by air blowing is employed, an operation of an air pump requires electric power. Further, for example, in the case where a method of cleaning the fixing member by bringing a cleaning member ordinarily spaced from the fixing member into contact with the fixing member is employed, with execution of the cleaning process, the electric power is required for a contact operation during the cleaning process and a spacing operation after the cleaning process.

### SUMMARY OF THE INVENTION

A principal object of the present invention is to provide an image forming apparatus capable of suppressing, in a method in which different fixing devices (fixing portions) are replaced and selectively used, electric power consumption with a cleaning process while suppressing a deterioration of an image quality of a product by the fixing device (fixing portion) stored outside the image forming apparatus.

According to an aspect of the present invention, there is provided an image forming apparatus comprising: an image forming portion configured to form an image on a recording material; a fixing portion provided detachably mountable to a main assembly of the image forming apparatus and configured to fix, on the recording material, the image formed by the image forming portion, wherein the fixing portion includes a rotatable member contacting a surface of recording material, on which the image is formed, when the image is fixed, and includes a storing portion configured to store information on a time at which the fixing portion is demounted from the main assembly; an acquiring portion configured to acquire the information stored by the storing portion depending on mounting of the fixing portion in the main assembly; and a controller configured to control whether or not a cleaning process for removing a deposited matter on a surface of the rotatable member is executed depending on an elapsed time from the time indicated by the information acquired by the acquiring portion, wherein when the elapsed time is not less than a predetermined time, the controller executes the cleaning process in a period from the mounting of the fixing portion in the main assembly to a start of fixing, and when the elapsed time is less than the predetermined time, the controller does not executes the cleaning process in the period.

According to another aspect of the present invention, there is provided an image forming apparatus comprising: an image forming portion configured to form an image on a recording material; a fixing portion provided detachably mountable to a main assembly of the image forming apparatus and configured to fix, on the recording material, the image formed by the image forming portion, wherein the fixing portion includes a rotatable member contacting a surface of recording material, on which the image is formed, when the image is fixed, and includes a storing portion configured to store time information corresponding to a time from the main assembly; an acquiring portion configured to acquire the time information stored by the storing portion depending on mounting of the fixing portion in the main assembly; and a controller configured to control whether or not a cleaning process for removing a deposited matter on a surface of the rotatable member is executed depending on an elapsed time from the time indicated by the time information acquired by the acquiring portion, wherein when the elapsed time is not less than a predetermined time, the controller executes the cleaning process in a period from the mounting of the fixing portion in the main assembly to a start of fixing, and when the elapsed time is less than the predetermined time, the controller does not executes the cleaning process in the period.

According to a further aspect of the present invention, there is provided an image forming apparatus comprising: an image forming portion configured to form an image on a recording material; a fixing portion provided detachably mountable to a main assembly of the image forming apparatus and configured to fix, on the recording material, the image formed by the image forming portion, wherein the fixing portion includes a rotatable member contacting a surface of recording material, on which the image is formed, when the image is fixed, and includes a discriminating portion indicating discrimination information for discriminating between the fixing portion and another fixing portion mountable in the main assembly so as to be replaceable with the fixing portion; a storing portion configured to store time information on a time at which the fixing portion is demounted from the main assembly corresponding to the discrimination information of the fixing portion; an acquiring portion configured to acquire, from the discriminating portion, the discrimination information of the fixing portion mounted in the main assembly, depending on mounting of the fixing portion in the main assembly; and a controller configured to control whether or not a cleaning process for removing a deposited matter on a surface of the rotatable member is executed depending on an elapsed time from the time indicated by the time information stored in the storing portion in association with the discrimination information acquired by the acquiring portion, wherein when the elapsed time is not less than a predetermined time, the controller executes the cleaning process in a period from the mounting of the fixing portion in the main assembly to a start of fixing, and when the elapsed time is less than the predetermined time, the controller does not executes the cleaning process in the period.

Further features of the present invention will become apparent from the following description of exemplary embodiments with reference to the attached drawings.

### BRIEF DESCRIPTION OF THE DRAWINGS

FIG. 1 is a sectional view showing an example of a schematic structure of an image forming apparatus.

FIG. 2 is a sectional view showing an example of a schematic structure of a fixing device.

FIG. 3 is a schematic view showing an example of an air cleaning mechanism.

FIG. 4 is an enlarged view of a nozzle portion of the air cleaning mechanism.

FIG. 5 is a schematic view for illustrating an example of arrangement of the air cleaning mechanism and a fixing member.

FIG. 6 is a block diagram showing an example of a control constitution of the image forming apparatus.

FIG. 7 is a table showing an example of kinds of fixing devices different in purpose of use.

FIG. 8 is a table showing an example of kinds of fixing devices different in purpose of use.

FIG. 9 is a flowchart showing control in the case where the fixing device is demounted.

FIG. 10 is a flowchart showing control in the case where the fixing device is mounted.

### DESCRIPTION OF THE EMBODIMENTS

Preferred embodiments of the present invention will be described specifically with reference to the drawings. However, constituent elements described in the embodiments are examples, and the present invention is not limited to such specific examples.

### Embodiment 1

### <General Structure of Image Forming Apparatus>

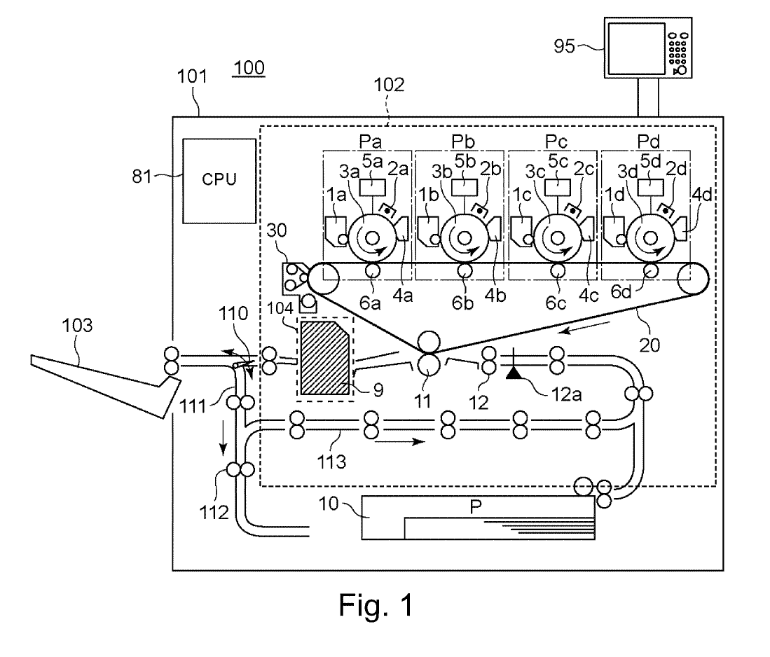

FIG. 1 is a sectional view showing an example of a schematic structure of an image forming apparatus 100. The image forming apparatus 100 is of an electrophotographic type, and forms an image on a recording material P. The image forming apparatus 100 shown in FIG. 1 includes an image forming portion and fixing portions inside a casing (main assembly) 101 thereof.

The image forming portions Pa, Pb, Pc, Pd form toner images of different colors (e.g., yellow, magenta, cyan, black) on an intermediary transfer member 20 through processes of latent image formation, development and transfer. The toner images formed on the intermediary transfer member 20 are transferred onto the recording material P by a secondary transfer roller (secondary transfer portion) 11. The recording material P on which the toner images are transferred is fed to a fixing device 9 functioning as a fixing portion, in which the toner images are fixed on the recording material P by heat and pressure, and then the recording material P is discharged onto a sheet discharging tray 103 (outside the casing 101). Details thereof will be described below.

The image forming portions Pa, Pb, Pc, Pd include exclusive image bearing members, i.e., photosensitive drums 3a, 3b, 3c, 3d in this embodiment, and form toner images of respective colors on the photosensitive drums 3a, 3b, 3c, 3d, respectively.

The intermediary transfer member 20 is provided adjacently to the photosensitive drums 3a, 3b, 3c, 3d. The toner images of the respective colors are primary-transferred from the photosensitive drums 3a, 3b, 3c, 3d onto the intermediary transfer member 20 by primary transfer rollers (primary transfer portions) 6a, 6b, 6c, 6d.

The photosensitive drums 3a, 3b, 3c, 3d are rotated in directions of arrows in the figure, and are subjected to processes of charging, exposure, development, transfer and cleaning. At outer peripheral portions of the photosensitive drums 3a, 3b, 3c, 3d, chargers 2a, 2b, 2c, 2d, developing devices 1a, 1b, 1c, 1d, the primary transfer rollers 6a, 6b, 6c, 6d and cleaners 4a, 4b, 4c, 4d are provided, respectively. In the image forming portions Pa, Pb, Pc, Pd, laser scanners 5a, 5b, 5c, 5d for exposing the photosensitive drums 3a, 3b, 3c, 3d charged by the chargers 2a, 2b, 2c, 2d to light are provided.

In the laser scanners 5a, 5b, 5c, 5d, unshown light source devices and polygon mirrors are provided. Laser beams (light) emitted from the light source devices are used to scan surfaces of the photosensitive drums by rotation of the polygon mirrors, and the light beams of the scanning light are deflected by reflecting mirrors and are focused on generatrices of the photosensitive drums 3a, 3b, 3c, 3d by unshown fθ lenses, so that the surfaces of the photosensitive drums are exposed to light. The laser scanners carry out the exposure depending on signals from a CPU (central processing unit) 81. As a result, latent images corresponding to an original image inputted into the CPU 81.

In the developing devices 1a, 1b, 1c, 1d, toners of yellow, magenta, cyan, black are filled as developers in predetermined amounts by unshown supplying devices. The developing devices 1a, 1b, 1c, 1d develop the latent images on the photosensitive drums 3a, 3b, 3c, 3d, respectively, and visualize the latent images as toner images of the respective colors.

The intermediary transfer member 20 is rotationally driven in a direction of an arrow in the figure at a peripheral speed equal to that of the photosensitive drums 3a, 3b, 3c, 3d. The toner image formed on the photosensitive drum 3a is primary-transferred onto an outer peripheral surface of the intermediary transfer member 20 by an electric field and pressure, which are formed by a primary transfer bias applied to the primary transfer roller 6a, in a process in which the toner image passes through a nip between the photosensitive drum 3a and the intermediary transfer member 20. This is true for also the photosensitive drums 3b, 3c, 3d.

Transfer residual toners remaining on the photosensitive drums 3a, 3b, 3c, 3d after the primary transfer are removed by the respective cleaners 4a, 4b, 4c, 4d.

The toner images transferred superposedly onto the intermediary transfer member 20 are transferred from the intermediary transfer member 20 onto the recording material P by a secondary transfer bias applied to a secondary transfer roller 11. The toner remaining on the intermediary transfer member 20 after the secondary transfer is removed by a cleaning web (nonwoven fabric) 30 provided so as to contact the surface of the intermediary transfer member 20. The recording material P is fed from a sheet feeding cassette 10 to a registration roller pair 12. The registration roller pair 12 feeds the recording material P to a contact nip between the intermediary transfer member 20 and the secondary transfer roller 11 in synchronism with timing when the toner image on the intermediary transfer member 20 reaches a secondary transfer portion.

The recording material P on which the toner image (unfixed) is formed at the secondary transfer portion is fed to a fixing device 9, in which the toner image is fixed on the recording material P by the fixing device 9 under application of heat and pressure.

In the case of double-side printing, the toner image is fixed on a first surface of the recording material P by the fixing device 9 and thereafter the recording material P is induced into a reverse path 111 by a flapper 110. Then, the recording material P is reversed by a reversing roller 112 and is introduced into a path 113 for double-sided printing. Then, the recording material P then passes through the registration roller pair 12 and the contact nip between the intermediary transfer member 20 and the secondary transfer roller 11 again, so that the toner image is transferred onto a second surface (opposite from the first surface) and then is fixed on the recording material P by the fixing device 9.

The recording material P on which the image is formed on the first surface in one-sided printing and the recording material P on which the image is formed on the second surface in the double-sided printing are introduced onto the sheet discharge tray 103 by the flapper 110 and thus is discharged as a product to an outside of the image forming apparatus.

Here, the recording material P refers to a recording material on which the image is to be formed by the image forming apparatus 100, and for example, it is possible to cite paper, an OHP sheet and the like.

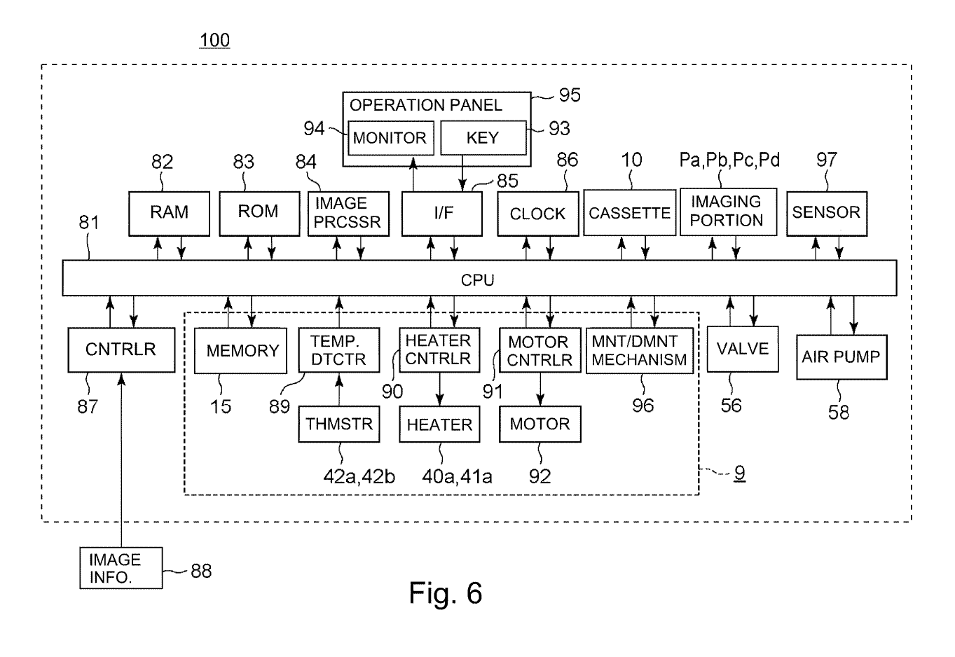

An operating panel (operating portion) 95 includes a monitor 94 functioning as a display portion for displaying information for the user and an operating key 93 functioning as an inputting portion through which the user inputs the information and an instruction (FIG. 6). Incidentally, the operating panel 95 is of a touch panel type and thus may also be constituted so that the display portion also functions as an inputting portion. An operator (user) is capable of not only providing an instruction of image formation start via the operating panel 95 but also carrying out setting of an image quality of the image and inputting information on the recording material P set in the sheet feeding cassette 10. On the basis of the image forming apparatus inputted through the operating panel 95, the CPU 81 determines an image forming condition and executes image formation under a determined condition.

Further, a front door 102 as an openable portion is a door provided at an opening of the casing 101 of the image forming apparatus 100. In the case where the operator mounts the fixing device 9 in a mounting portion 104 in the casing 101 or demounts the fixing device 9 from the mounting portion 104 in the casing 101, the operator opens the front door 102, and thus can access to the mounting portion 104 of the fixing device 9 in the casing 101.

The image forming apparatus 100 includes an opening/closing sensor (optical sensor) 97 (FIG. 6) as a sensor for detecting that the front door 102 is in a closed state. The opening/closing sensor 97 and the CPU 81 function as an opening/closing detecting portion. The front door 102 is provided with projections (unshown) and by closing the front door 102, the projections are inserted into receiving portions (unshown) of the casing 101 of the image forming apparatus 100. With the insertion of the projections into the receiving portions, the CPU 81 detects that the front door 102 is closed, on the basis of a signal sent by the opening/closing sensor 97. On the other hand, when the signal from the opening/closing sensor 97 is not outputted, the CPU 81 detects that the front door 102 is open. The opening/closing sensor 97 may also have the following constitution. That is, a constitution in which with the opening of the front door 102, the CPU 81 detects that the front door 102 is open on the basis of the signal sent by the opening/closing sensor 97, and on the other hand, when the signal from the opening/closing sensor 97 is not outputted, the CPU 81 detects that the front door 102 is closed may also be employed.

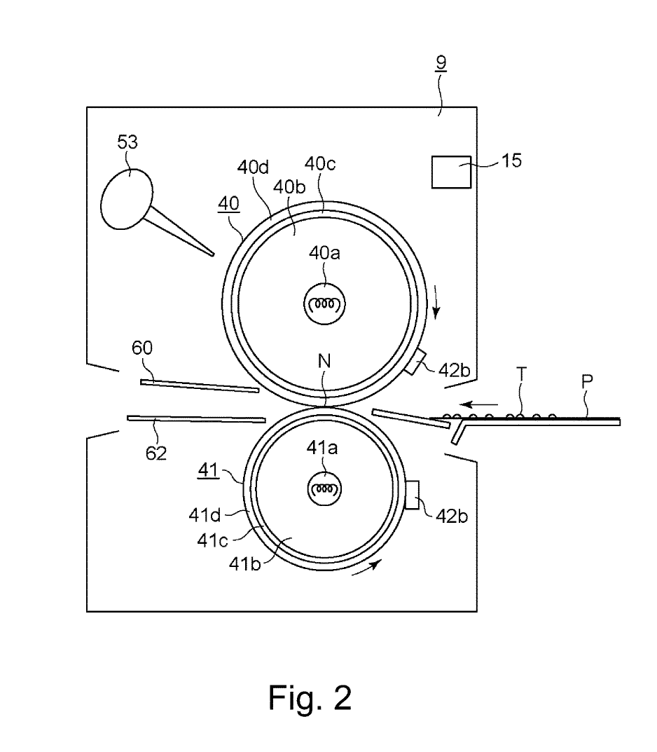

FIG. 2 is a sectional view showing an example of a schematic structure of the fixing device 9.

An unfixed toner image T secondary-transferred on the recording material P is nipped and fed through a heating nip N formed by a fixing roller (rotatable member) 40 and a pressing roller 41 and is fixed on the recording material P. The fixing roller (rotatable member) 40 is a roller contacting the surface of the recording material P where the unfixed toner image T is formed.

In the fixing device 9, the pressing roller 41 is press-contacted to the fixing roller 40 at a total pressure of 784 N (about 80 kgf), so that the heating nip N is formed.

The fixing roller 40 is constituted so as to have a diameter of 80 mm by forming a 3 mm-thick elastic layer 40c on an outer peripheral surface of the core metal 40b which is an aluminum-made cylinder and by forming a 50 μm-thick parting layer 40d, to be contacted to an image surface, or another peripheral surface of the elastic layer 40c. The elastic layer 40c is an HTV (high-temperature vulcanizing) silicone rubber layer, and the parting layer 40d is a tube principally formed of a copolymer of tetrafluoroethylene and perfluoroalkoxyethylene (hereinafter referred to as PFA).

The pressing roller 41 is constituted so as to have a diameter of 60 mm by forming a 1 mm-thick elastic layer 41c on an outer peripheral surface of the core metal 41b which is an aluminum-made cylinder, and by forming a parting layer 41d on an outer peripheral surface of the elastic layer 41c. The elastic layer 40c is, similarly as in the fixing roller 40, an HTV silicone rubber layer, and the parting layer 41d is a PFA tube.

At rotation centers of the fixing roller 40 and the pressing roller 41, heaters 40a and 41a for heating the rollers 40 and 41, respectively, are provided non-rotationally. In this embodiment, as the heater 40a, a halogen heater of 1200 W in normal rated power was used, and as the heater 41a, a halogen heater of 400 W in normal rated power was used. ON/OFF of the heaters 40a, 41a is controlled by a heater controller 90 (FIG. 6) provided in the fixing device 9. Thermistors 42a, 42b which are temperature detecting elements detect surface temperatures of the fixing roller 41 and the pressing roller 41, respectively. A temperature detecting portion 89 transmits outputs of the thermistor 42a, 42b to the CPU 81. On the basis of output results of the thermistor 42a, 42b acquired from the temperature detecting portion 89, the CPU 91 provides an instruction to the heater controller 90 so that the fixing roller 40 and the pressing roller 41 maintains target temperatures thereof, respectively.

Further, the fixing roller 40 and the pressing roller 41 are supported by ball bearings at end portions thereof and thus are rotatable. The fixing roller 40 is rotated in an arrow direction in FIG. 2 by drive of a motor 92 (FIG. 6) as a driving means. Further, the pressing roller 41 is rotated by the fixing roller 40 and is rotated in an arrow direction in FIG. 2. The drive of the motor 92 is controlled by a motor controller 90 (FIG. 6) provided in the fixing device 9. The motor controller 91 is controlled by the CPU 81. Further, the pressing roller 41 is detachably mountable to the fixing roller 40 by a mounting/demounting mechanism 96 (FIG. 6).

Further, in the fixing device 9, a memory 15 is provided.

### <Air Cleaning Mechanism>

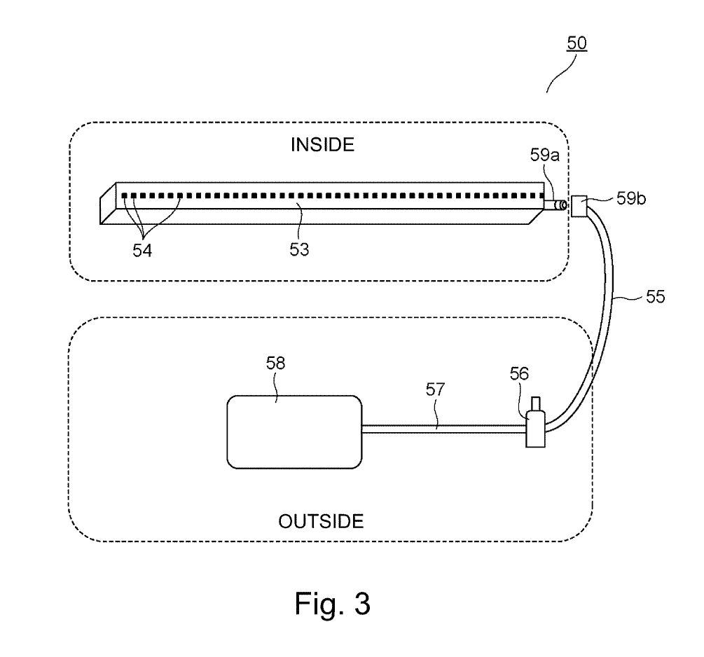

The image forming apparatus 100 includes an air cleaning mechanism (air blowing member) 50 for removing a deposited matter (e.g., dirt or dust) on the fixing roller 40 by blowing air to the fixing roller 40. In this embodiment, the air cleaning mechanism 50 functions as a cleaning portion for removing the deposited matter on the fixing roller 40 by the cleaning process. In the air blowing constitution, the cleaning mechanism can effect cleaning in non-contact with the surface of the fixing roller 40, so that generation of damage on the fixing roller 40 by the cleaning can be prevented. In this embodiment, a constitution in which an air pump 58 and an electromagnetic valve 56 are combined and an air nozzle 53 provided with a plurality of holes (openings) 54 as air blowing ports was employed. FIG. 3 is a schematic view showing an example of the air cleaning mechanism 50.

The air pump 58 is a compressor for generating high-pressure air. The high-pressure air generated by the air pump 58 is introduced into the electromagnetic valve 56 via an air piping 57. The electromagnetic valve 56 is a valve for blocking or permitting air flow between the air piping 57 and an air piping 55. Only in the case where the electromagnetic valve 56 is open, air is ejected from the air nozzle 53, and therefore the electromagnetic valve 56 performs the function of a switch for controlling ON/OFF of the air ejection (blow) from the air nozzle 53.

At an end portion of the air nozzle 53, a fixing-side coupler 59a is provided. The fixing-side coupler 59a is configured to be connected with a main assembly-side coupler 59b provided at an end portion of the air piping 55.

In a state in which the fixing device 9 is mounted on the casing 101, when the electromagnetic valve 56 is released, the high-pressure air supplied from the air pump 58 passes through the air piping 55 and is introduced into the air nozzle 53 provided in the fixing device 9, so that the pressure is uniformly exerted on an inside of the air nozzle 53. Then, the air is jetted from the plurality of holes 54 provided in the air nozzle 53. At this time, when the electromagnetic valve 56 is continuously opened, an ejection pressure of the air jetted from the holes 54 decreases with a lapse of a time, and therefore the CPU 81 controls opening and closing of the electromagnetic valve 56 and thus effects control so that the air ejection pressure falls within a certain range. That is, the air ejection (blowing) is carried out intermittently.

The air nozzle 53 is a cylindrical pipe member formed of metal excellent in heat-resistant property and pressure-resistant property. At a downstream end portion of the air nozzle 53, an aluminum material relatively low in hardness and high in malleability of those of metals is used and is subjected to crushing (process) for preventing air leakage. The air leakage can be prevented by sealing the air nozzle at a downstream end by crushing and flattening the downstream end without providing a bonding portion to the air nozzle 53. As a result, the air cleaning mechanism 50 can blow the air to the fixing roller 40 with a stable ejection pressure.

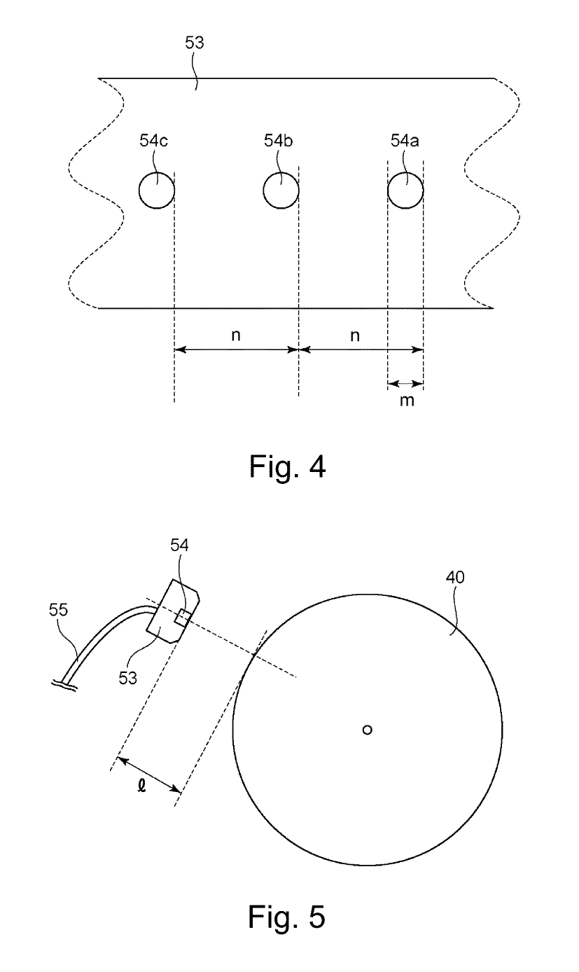

FIG. 4 is an enlarged view of a nozzle portion of the air cleaning mechanism. Each of the holes 54 is 1 mm in diameter m, and an interval n between adjacent holes 54 is 5 mm. There is a limit to a flow rate of the air which can be supplied by the air pump 58, and therefore there is a liability that when the flow rate of the air ejected from the holes 54 exceeds the flow rate of the air supplied by the air pump 58, the air pressure lowers and thus improper cleaning generates. Therefore, the number of the holes 54 provided in the air nozzle 53 is the number such that a total flow rate of the air ejected from all of the holes 54 provided in the air nozzle 53 does not exceed the supply flow rate of the air from the air pump 58. Further, a gap 1 (FIG. 5) between the fixing roller 40 and the holes (openings) 54 is 3 mm. FIG. 5 is a schematic view for illustrating an example of an arrangement of the air cleaning mechanism and the fixing member, and shows a cross-section of the fixing roller 40.

Incidentally, in this embodiment, the constitution of the air cleaning mechanism 50 is not limited to the above-described constitution. For example, a constitution in which the high-pressure air is supplied using a cylinder of air or nitrogen may also be employed. Further, a constitution in which an air blowing fan as an air supplying portion and an air blowing duct for sending the air from the air blowing fan to the surface of the fixing roller 40 are used in combination may also be used.

### <Constitution Concerning Control>

FIG. 6 is a block diagram showing an example of a control constitution of the image forming apparatus. The CPU 81 is electrically connected with the respective controller (the temperature detecting portion 89, the heater controller 90, the motor controller 91) of the fixing device 9 mounted in the image forming apparatus 100, the mounting/demounting mechanism 96 of the fixing device 9 and the memory 15 of the fixing device 9. Further, the CPU 81 is electrically connected with the sheet feeding cassette 10, the image forming portions Pa, Pb, Pc, Pd, the opening/closing sensor 97, the air pump 58, the electromagnetic valve 56, an I/F portion 85, a clock 86, a controller 87, an image processing portion 84, an ROM (read only memory) 83 and an RAM (random access memory) 83 and an RAM (random access memory) 82.

Further, the CPU 81 is electrically connected with also the operating panel 95 via the I/F portion 85. The I/F portion 85 may also be constituted so as to be connectable with an external terminal such as a personal computer provided outside the image forming apparatus 100.

Image information 88 such as a printing condition and original image data is sent, to the CPU 81 via the controller 87, e.g., from the personal computer connected with the image forming apparatus 100 via a network or a scanner unit or the like connected with the image forming apparatus 100. The CPU 81 subjects the image information 88 received via the controller 87 to image processing by the image processing portion 84, and on the basis of the processed data, the CPU 81 executes an image forming process for forming the toner image on the recording material P by controlling the image forming portions Pa, Pb, Pc, Pd and the fixing device 9, and the like.

The image forming apparatus 100 includes the clock 86, so that the CPU 81 acquires time information.

In the ROM 83, programs for controlling the respective portions, such as the image processing portion 84, the operating panel 95 and the fixing device 9, which are electrically connected with the CPU 81 are stored, and are controlled by the CPU 81. The RAM 82 is used as a work area when the CPU 81 executes the programs.

### <Fixing Device Replacing System>

Next, replacement of the fixing device 9 will be described. In recent years, due to various customer's needs, the kinds of recording materials subjected to image formation are diversified. For example, envelopes, sheets having large basis weights, and the like are used. In order to obtain a high-quality product, a method in which a plurality of fixing devices different in purpose of use are prepared and are selectively used by replacing the fixing device depending on the type of the recording material P printed or preference of the user has been proposed. This method is referred in this embodiment as a fixing device replacing system. By using the image forming apparatus 100 in which the fixing device is replaced with a fixing device for which setting meeting the recording material P used is made, it becomes possible to meet many types of recording materials P by a single image forming apparatus 100.

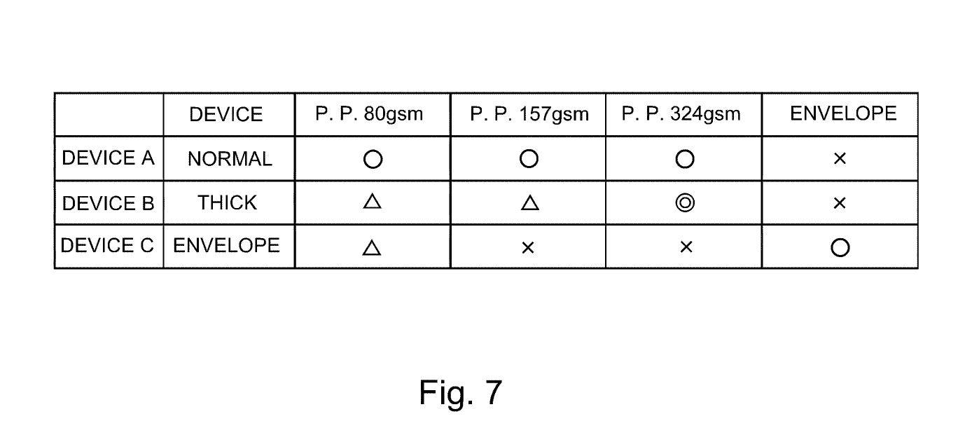

FIG. 7 is a table showing an example of the types of the fixing devices different in purpose of use. For example, as the fixing devices different in purpose of use, a fixing device A, a fixing device B and a fixing device C are prepared and are selectively used depending on the type of the recording material P. In FIG. 7, “P.P.” represents plain paper.

The fixing device A widely meets the types of general-purpose recording material P. This fixing device A is referred to as a normal fixing device (for general purpose). In the case where a sheet (plain paper) having a basis weight which is 4-5 times that (about 64-80 gsm) of the sheets which are relatively used frequently in an ordinary office is used, there is a liability that even when a fixing temperature of the fixing device A is increased by several tens of ° C., a heat quantity is insufficient. Further, a large pressure is exerted on a thick recording material P at the nip and a pressure difference between a passing region and a non-passing region of the recording material P is large, and therefore a stress on the fixing roller 40 and the pressing roller 41 becomes large. For this reason, there is a liability that a deterioration and consumption of the surfaces of the members are accelerated.

Therefore, the fixing device B places importance on the fixing of the thick recording material P, and a constitution in which a fixing nip width is broadened and thus the pressure is distributed is employed. This fixing device B is referred to as a fixing device for thick paper. However, in the case of this setting, when a thin recording material P is used, there is a liability that creases and uneven glossiness are liable to generate.

Further, in the case where the fixing is intended to be satisfactorily carried out on an envelope, the fixing device C for which the pressure at the nip is adjusted to a pressure suitable for the envelope (i.e., the pressure is about half the pressure in the case of the fixing device A) is used. By decreasing the pressure, the stress on the envelope is alleviated, so that the creases and the uneven glossiness can be suppressed. This fixing device C is referred to as a fixing device for envelope. In this case, when the normal recording material P and the thick recording material P particularly requiring a large heat quantity are used, there is a liability that in conveniences such as cold offset in which the toner is not fixed on the sheet but is offset toward the fixing roller side and a lowering glossiness due to a phenomenon that the toner is not sufficiently melted and a surface property becomes rough generate.

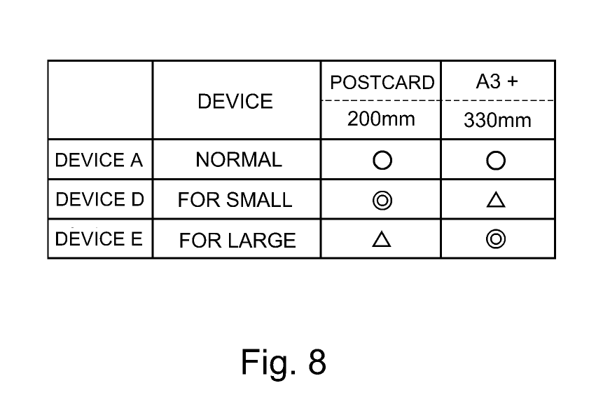

FIG. 8 is a table showing an example of the types of the fixing devices different in purpose use. As another example of the selective use, there is a selective use depending on a size of the recording material with respect to a direction perpendicular to a feeding direction of the recording material (herein, this size is referred to as a widthwise size).

When the recording materials P having the same size are repetitively passed through the nip N, non-uniformity of surface roughness of the fixing roller 40 and the pressing roller 41 with respect to a longitudinal direction (perpendicular to the feeding direction of the recording material P) generates. Specifically, when the recording materials P having the same size are repetitively passed through the nip N, the surfaces of the fixing roller 40 and the pressing roller 41 are damaged by contact with an end portion of the recording material P with respect to the direction perpendicular to the feeding direction of the recording material P (hereinafter, this end portions referred to as an edge portion). In the passing region of the recording material P, by the contact of the fixing roller 40 and the spacing roller 41 with the recording material P, the surfaces of the fixing roller 40 and the pressing roller 41 are levelled off. Further, in the non-passing region of the recording material P, the fixing roller 40 and the pressing roller 41 are driven in contact with each other, and therefore are not adversely affected by the recording material P. In this state, in the case where the recording material P having the widthwise size larger than that of the recording materials P which were repetitively passed through the nip N is subjected to the fixing process, there is a liability that the non-uniformity of the surface property of the predetermined 40 and the pressing roller 41 is reflected in the toner image and is recognized as the uneven glossiness. Therefore, the fixing devices for the respective widthwise sizes are prepared and are used depending on the widthwise size of the recording material P printed, so that the above-described uneven glossiness can be suppressed.

Usually, the fixing device A is used. In the case where the user is particularly concerned about a gloss property of a product, an operator replaces the fixing device A with a fixing device D or a fixing device E. For example, in the case where the user effects both of double-sized printing on a postcard and printing of the image on A3+(SRA3)-sized paper, the fixing device D (for small size) is used for two(double)-side printing postcard having a width of 200 mm, and the fixing device E (for large size) is used in the case of the A3+(SRA3)-sized paper. As a result, the fixing can be carried out with no contact of portions of the fixing roller 40 and the pressing roller 41 different in surface property with the toner image on the recording material P, and therefore it is possible to obtain a product with suppressed uneven glossiness.

### <Cleaning Process in Fixing Device Replacing System>

In the fixing device replacing system, the plurality of fixing devices different in purpose of use are prepared, and one of the fixing devices is used as the fixing device 9. In the following, for conveniences, as an example of the fixing device used as the fixing device 9, the case where two fixing devices, i.e., the fixing device A and the fixing device B are used will be described as an example. Depending on the purpose of use, the operator uses the fixing device A as the fixing device 9 or uses the fixing device B as the fixing device 9 after demounts the fixing device A from the image forming apparatus 100, or demounts the fixing device B from the image forming apparatus 100 and then mounts and uses the fixing device A again in some cases.

In this fixing device replacing system, during the mounting of the fixing device B as the fixing device 9 in the image forming apparatus 100, the fixing device A which is not used in the image forming apparatus 100 is stored outside the image forming apparatus 100 (casing 101) by the user. At this time, depending on a storing environment by the user, there is a liability that dust (e.g., dirt such as waste textile) is deposited on members in the fixing device A. Therefore, the fixing device A is mounted again in the image forming apparatus 100 and is used as the fixing device 9. In this case, particularly when the fixing process is carried out in a state in which the dust is deposited on the surface of the fixing roller 40 as the member in the fixing device A, there is a liability that the dust is deposited on the image on the recording material with the fixing process. That is, there is a liability that an image quality of the product deteriorates.

Therefore, in the image forming apparatus 100 in this embodiment, an air cleaning mechanism 50 is provided as a cleaning member for removing the dust (deposited matter) on the surface of the fixing roller 40 of the fixing device stored outside the image forming apparatus 100 (casing 101). In the case where the fixing device having a liability that the dust is deposited on the surface of the fixing roller 40 is mounted as the fixing device 9, the image forming apparatus 100 executes a process (cleaning process) of removing the dust from the surface of the fixing roller 40 before the fixing device 9 starts the fixing process of the image on the recording material P.

On the other hand, even in the case where the fixing device 9 is replaced with the fixing device A, when an unmounting time of the fixing device A is short, a storing time of the fixing device A in the outside of the image forming apparatus is short, so that there is substantially no possibility that the dust is deposited on the surface of the fixing roller 40 of the fixing device A. Therefore, in the case where the fixing device A having a short unmounting time in the image forming apparatus 100 is mounted in the image forming apparatus 100, the cleaning process is not carried out. As a result, there is no need to carry out switching of the operation of the air pump 58 and switching of the electromagnetic valve 56 of the air cleaning mechanism 50 for performing the cleaning process, so that electric power consumption with execution of the cleaning process can be suppressed.

Therefore, the fixing device 9 (i.e., each of the fixing devices A, B used as the fixing device 9) includes a memory 15 as a storing portion for storing information. The CPU 81 causes the memory 15 to store information indicating a time at which the fixing device 9 is demounted from the image forming apparatus 100. Specifically, the CPU (recording portion, writing portion) 81 records (writes) time information as a demounted time in the memory 15 of the fixing device 9 mounted in the image forming apparatus 100 immediately before the fixing device 9 mounted in the image forming apparatus 100 is taken out by the user.

In the case where the fixing device 9 is mounted again in the image forming apparatus 100, when a time at which the fixing device 9 which had been mounted in the image forming apparatus 100 is kept in a demounted state is not less than a predetermined time, the cleaning process is executed before the fixing device 9 starts the fixing process. On the other hand, in the case where the time at which the fixing device 9 which had been mounted in the image forming apparatus 100 is kept in the demounted state is less than the predetermined time, the fixing device 9 starts the fixing process without executing the cleaning process. Specifically, the CPU 81 (acquiring portion) 81 acquires information on the demounted time stored in the memory 15 of the fixing device 9 mounted in the image forming apparatus 100. The CPU 81 acquires an elapsed time, from the demounting of the fixing device 9, from the demounted time acquired from the memory 15 and a clock 86 indicating a current time.

### <Control Flow>

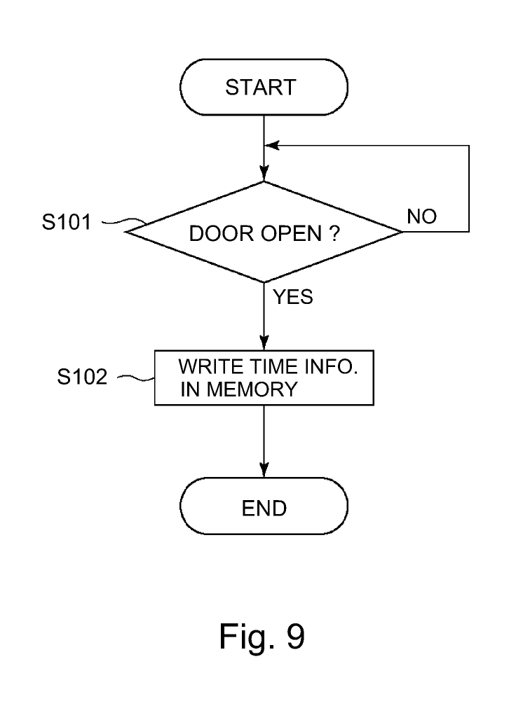

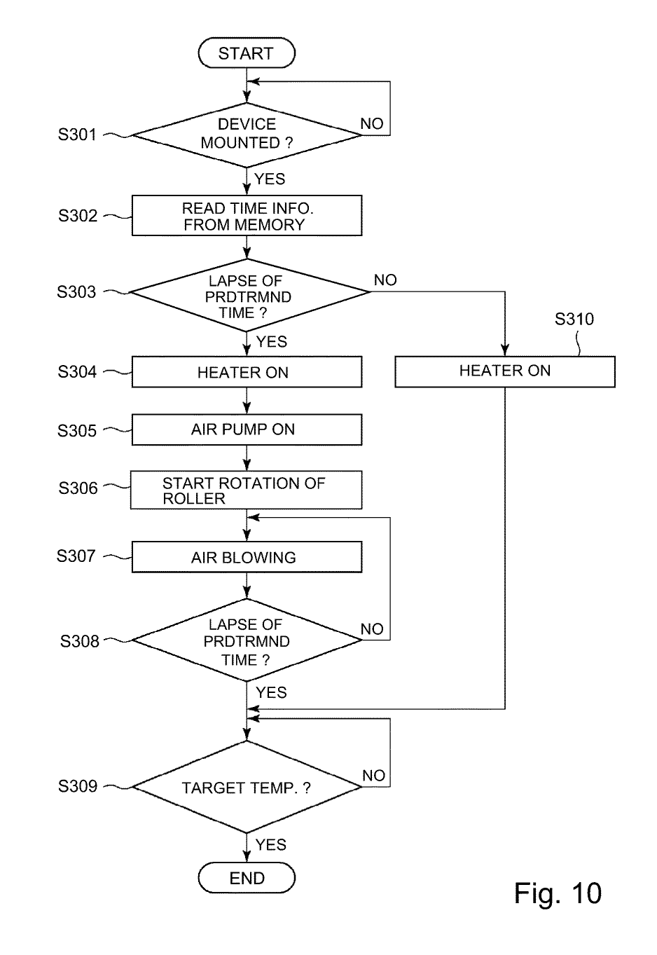

In the following, details of control before and after the replacement of the fixing device 9 in the image forming apparatus 100 will be described. Flowcharts shown in FIGS. 9 and 10 are carried out by the CPU 81 functioning as an executing portion by controlling operations of the respective mechanisms of the image forming apparatus 100 on the basis of control programs stored in the ROM 83.

FIG. 9 is the flowchart showing the control in the case where the fixing device is demounted. In the case where the fixing device A as the fixing device 9 mounted in the image forming apparatus 100 is replaced with the fixing device B, the operator opens the front door 102 and then demounts the fixing device A which has already been mounted in the image forming apparatus 100. There is a time lag from the opening of the front door 102 to actual demounting of the fixing device A from a mounting portion in the casing 101.

Therefore, the CPU 81 uses the opening of the front door 102 as a trigger (S101), and records time information in the memory 15 of the fixing device A immediately before the opening (until the fixing device A and the CPU 81 is electrically disconnected by the demounting) (S102). The opening of the front door 102 is detected by the opening/closing sensor 97. In this embodiment, the time information recorded by the CPU 81 is a time outputted by the clock 86 when the opening/closing sensor 97 detects the opening of the front door 102. In this embodiment, this time is referred to as the demounted time.

In the case where the fixing device A as the fixing device 9 mounted in the image forming apparatus 100 is replaced with the fixing device B, the operator opens the front door 102 and demounts the fixing device A which has already been mounted in the image forming apparatus 100, and thereafter, the operator mounts the fixing device B in the image forming apparatus 100 and closes the front door 102.

After the fixing device B is mounted in the image forming apparatus 100 and the front door 102 is closed, the image forming apparatus 100 performs a preparatory warm-up operation for putting the image forming apparatus 100 in a state (stand-by state) in which the image forming apparatus 100 can start an image forming process. The stand-by state in a state in which the image forming apparatus 100 is capable of starting the image forming process and refers to a period of a state in which the image forming apparatus 100 waits for a print instruction (print job) from the operator. As one of processes of this warm-up operation, temperature adjusting control for heating the fixing roller 40 and the pressing roller 41 of the fixing device 9 up to target temperatures is executed. The target temperature of the fixing device 9 in the warm-up operation is a stand-by temperature in the stand-by state. The heaters 41a, 41b heat the fixing roller 40 and the pressing roller 41 and increase a surface temperature of the fixing roller 40 up to a temperature of a toner meltable (fusable) state.

In the case where printing prevention is made during the warm-up operation, the CPU 81 may also change the target temperatures of the fixing roller 40 and the pressing roller 41 to temperatures at which the reserved print job is executed.

FIG. 10 is the flowchart showing control in the case where the fixing device is mounted.

First, when the fixing device 9 is mounted in the image forming apparatus 100 (S301), the CPU 81 reads the time information stored in the memory 15 of the fixing device 9 (S302). Here, the time information read by the CPU 81 is the time information recorded when the fixing device 9 is last demounted (S102 in FIG. 9). By the mounting of the fixing device 9 in the image forming apparatus 100, the CPU 81 has access to the memory 15 of the fixing device 9. The CPU 81 accesses the memory 15 with detection of the closing the front door 102 by the opening/closing sensor 97. As a result, the CPU 81 checks whether or not a first fixing device 150 is mounted. When the CPU 81 does not have access to the memory 15, the CPU 81 discriminates that the fixing device 9 (first fixing device) is not mounted. A method of discriminating (checking) whether or not the fixing device 9 is mounted is not limited thereto, but for example, a constitution in which a conduction state or a non-conduction state between the image forming apparatus 100 and the fixing device 9 may also be employed.

The CPU 81 discriminates whether or not an elapsed time from the demounted time acquired from the memory 15 in S302 is not less than a predetermined time (S303). The CPU 81 is capable of acquiring the elapsed time, of the fixing device 9 from the demounting of the fixing device 9, from the demounted time acquired from the memory 15 and the clock 86 indicating the current time. The predetermined time as a criterion of the discrimination is stored in the ROM 83 or the RAM 82 in advance.

When the elapsed time from the demounted time is not less than the predetermined time (YES OF S303), the CPU 81 discriminates that there is a need to carry out a process (cleaning process) for removing the dust (deposited matter) from the surface of the fixing roller 40. The CPU 81 turns on the heater 40a for the fixing roller 40 and the heater 41a for the pressing roller 41, and then starts the temperature adjusting control (S304).

The CPU 81 starts an operation of the air pump 58 (S305). In the air piping 57, high-pressure air is filled. The CPU 81 drives a motor 92 of the fixing roller 40 and starts rotation of the fixing roller 40 (S306). For example, a surface speed of the fixing roller 40 during rotation is 300 mm/s. The rotation of the fixing roller 40 may also be started after the temperatures of the fixing roller 40 and the pressing roller 41 reach the predetermined temperatures.

The CPU 81 opens the electromagnetic valve 56 and supplies compressed air from the air pump 58 to the air nozzle 53, so that the compressed air is jetted (ejected) toward the fixing roller 40 (S307). As a result, the dust (deposited matter) on the surface of the fixing roller 40 is removed. Here, the reason why the air is blown while rotating the fixing roller 40 is that a full-peripheral surface of the fixing roller 40 is cleaned. The air blowing is effected intermittently from the start of the rotation of the fixing roller 40 to a lapse of a predetermined time (S308). In S308, when the predetermined time has elapsed, the CPU 81 ends the air blowing (i.e., ends the cleaning process), and causes the process to go to S309. As regards the predetermined time, a time enough to remove the dust (deposited matter) on the surface of the fixing roller 40 is set in advance. The CPU 81 also functions as a timer for measuring the predetermined time in the cleaning process.

On the other hand, in S303, when the elapsed time from the demounted time is less than the predetermined time (NO of S303), the CPU 81 discriminated that there is no deposition of the dust on the fixing roller 40 and does not execute the cleaning process. That is, the CPU 81 does not execute the air blowing onto the fixing roller 40. The CPU 81 turns on the heater 40a for the fixing roller 40 and the heater 41a of the pressing roller 41, and starts the temperature adjusting control (S310), and then causes the process to go to S309.

In S309, when the CPU 81 detects that both of the temperatures of the fixing roller 40 and the pressing roller 41 reached the associated target temperatures, respectively, the CPU 81 ends the warm-up operation of the fixing device 9, and moves the state of the image forming apparatus 100 to the stand-by state. In this embodiment, the target temperature is a stand-by temperature in the stand-by state, and for example, 180° C. for the fixing roller 40 and 100° C. for the pressing roller 41. These values are examples and are not limited thereto. Incidentally, during the warm-up operation, in the case where the printing reservation is made, the CPU 81 does not put the image forming apparatus 100 into the stand-by state but may start the printing. In this case, the target temperature is a temperature at which the reserved print job is executed.

As described above, in the case where the fixing device 9 for which not less than the predetermined time has elapsed from the demounted time is mounted, the CPU 81 executes the cleaning process of the fixing roller 40 before the image forming apparatus state moves to the stand-by state (or before the print job starts). That is, the fixing device 9 stored for a while outside the casing 101 of the image forming apparatus 100 is subjected to the cleaning process of the fixing roller 40 after being mounted in the image forming apparatus 100 again and before the fixing process is started. As a result, it is possible suppress a deterioration in image quality of a product due to the dust deposited on the fixing roller 40 of the fixing device 9 taken out from the image forming apparatus 100 and stored outside the image forming apparatus 100.

Further, in the case where the fixing device 9 for which only less than the predetermined time has elapsed from the demounted time is mounted in the image forming apparatus 100, the CPU 81 does not execute the cleaning process of the fixing roller 40 before the state of the image forming apparatus 100 moves to the stand-by state (or before the print job is started). As a result, even the fixing device once taken out from the image forming apparatus 100, the cleaning process is not executed as regards the fixing device 9having a low possibility of deposition of the dust on the fixing roller 40, and therefore, it is possible to suppress electric power consumption with the cleaning process.

### Embodiment 2

In Embodiment 1, the constitution in which the air cleaning mechanism 50 is provided as the member (cleaning portion) for executing the cleaning process was employed, but the air cleaning mechanism 50 may also be constituted so as to also have the function of air separation. That is, the air cleaning mechanism 50 blows the air during the execution of the fixing process of the image on the recording material P. Specifically, during the execution of the fixing process, the air cleaning mechanism 50 blows the air for separating the recording material P, passing through the nip, from the fixing roller 40 so that the recording material P on which the image is fixed by the fixing device 9 is not wound about the fixing roller 40 after passing through the nip.

### Embodiment 3

In the above-described Embodiments 1 and 2, the constitution in which the air cleaning mechanism 50 is provided the deposited matter on the fixing roller 40 is removed by blowing the air to the fixing roller 40 was employed, but a method of executing the cleaning process is not limited thereto.

For example, a constitution in which a cleaning web formed of non-woven fabric is provided as the cleaning portion and the deposited matter is wiped with the cleaning web by rubbing the surface of the fixing roller 40 with the cleaning web may also be employed. Specifically, a supplying roller for stacking an unused cleaning web, a winding-up roller for intermittently winding up the cleaning web supplied from the supplying roller, and an urging roller, rotatably provided, for urging the cleaning web against the fixing roller 40 are prepared. The winding-up roller includes a solenoid as a driving source, and the supplying roller supplies the cleaning web by the drive of the winding-up roller. In this case, there is a need to supply electric power for driving the solenoid during the execution of the cleaning process.

Further, for example, a constitution in which a rubber roller or a brush or the like is provided in place of the air cleaning mechanism 50 and the deposited matter is removed by sliding the surface of the fixing roller 40 with the rubber roller or the brush may also be employed. In this case, the rubber roller or the brush (cleaning portion) is usually put in a spaced state from the fixing roller 40, and is contacted to the fixing roller 40 by being supplied with the electric power with the execution of the cleaning process.

### Embodiment 4

In the above-described Embodiments 1 to 3, the constitution in which in the case where the fixing device 9 is demounted, the opening of the front door 102 acts as a trigger and the CPU 81 records the demounted time of the fixing device 9 in the memory 15 was employed, but the trigger for recording the demounted time is not limited thereto.

For example, the mounting portion of the fixing device 9 is provided with a locking mechanism released by the operator when the fixing device 9 is demounted, and the release of the locking mechanism acts as a trigger and the CPU 81 may record the demounted time of the fixing device 9 in the memory 15.

Further, for example, a constitution in which the operating panel 95 is operated by the operator immediately before exchange (replacement) of the fixing device 9 is employed, and an input indicating execution of the exchange of the fixing device is made through the operating panel 95. The input acts as a trigger and the CPU 81 may also record the demounted time of the fixing device 9 in the memory 15.

### Embodiment 5

In the above-described Embodiments 1 to 4, the constitution in which in the case where the fixing device 9 is demounted, the CPU 81 records the demounted time of the fixing device 9 in the memory 15 and in which the CPU 81 determines whether or not the cleaning process should be executed depending on the elapsed time from the demounted time was employed. However, a starting point of the elapsed time depending on which whether or not the cleaning process should be executed may also be the latest update time of the fixing device 9 recorded in the memory 15. That is, in this embodiment, the update time is the demounted time.

Specifically, during energization (including the stand-by state or the like) to the image forming apparatus 100, the CPU 81 accesses to the memory 15 with a frequency of not less than a certain one and records the update time. In the case where the fixing device 9 is mounted, the CPU 81 acquires the update time recorded in the memory 15 and determines whether or not the cleaning process should be executed depending on the elapsed time from the demounted time. That is, the starting time of the elapsed time depending on which whether or not the cleaning process should be executed is determined may also be not the time information recorded by the CPU 81 depending on the trigger, such as the opening of the front door 102, with the exchange of the fixing device 9. Incidentally, the update time includes an access log which is record of the access to the memory 15 by the CPU 81, and also includes the case where information other than the update time in the memory 15 is not renewed.

### Embodiment 6

In the above-described Embodiments 1 to 5, the constitution in which in the case where the time in which the fixing device 9 mounted in the image forming apparatus 100 had been demounted before being mounted is less than the predetermined time, the fixing process is started without executing the cleaning process was employed. However, a constitution in which exception handling (process) is executed may also be employed.

For example, even in a state in which the fixing device 9 is kept in the mounted state in the image forming apparatus 100, in the case where a time (T1) in which the power source of the image forming apparatus 100 is turned off is long, as a part of an initializing operation with turning-on of the power source, the air cleaning mechanism 50 may also be operated.

In the case of this constitution, it is desirable that an elapsed time (T3) from the demounted time which is a criterion of discrimination of whether or not the cleaning process shown in Embodiment 1 should be executed is set to satisfy T3<T1.

This is because an environment outside the image forming apparatus 100 varies depending on the user, and therefore there is a liability that the dust deposits on the surface of the fixing roller 40 in a short time compared with the inside of the image forming apparatus 100.

For example, even in a state in which the fixing device 9 is kept in the mounted state in the image forming apparatus 100, in the case where a time (T2) in which energization to the heater of the fixing device 9 is turned off is long, as a part of an initializing operation, the air cleaning mechanism 50 may also be operated. Also in the case of this constitution, it is desirable that an elapsed time (T3) from the demounted time which is a criterion of discrimination of whether or not the cleaning process shown in Embodiment 1 should be executed is set to satisfy T3<T2.

In this embodiment, the case where this embodiment is applied to Embodiment 1 was described, but this is true for also other embodiments.

### Embodiment 7

In the above-described Embodiments 1 to 6, the constitution in which in the case where the fixing device 9 is provided with the memory 15 and the CPU 81 records information showing the demounted time in the memory 15 was employed, but the place where the demounted time is stored is not limited to the memory 15 of the fixing device 9.

For example, a constitution in which the demounted time is stored in the RAM 82 provided in the image forming apparatus 100 in association with discrimination (identification) information of the fixing device 9 may also be employed. That is, the RAM 82 functions as the storing portion for storing the demounted time. Specifically, the memory 15 of the fixing device 9 stores ID (identification (discrimination)) information (such as fixing device A or fixing device B) for discriminating the fixing device 9 from other fixing devices capable of being replaced (exchanged) with the fixing device 9 and being mounted in the mounting portion 104 of the image forming apparatus 100. That is, the memory 15 of the fixing device 9 functions as a discriminating (identifying) portion.

The CPU (acquiring portion) 81 acquires the ID of the fixing device 9 form the memory 15 during the mounting of the fixing device 9 in the image forming apparatus 100. In the case where the fixing device 9 is demounted, the CPU 81 records the demounted time in association with the ID of the fixing device 9 to be demounted, by using the opening of the front door 102 as the trigger. Then, in the case where the fixing device 9 is mounted again in the image forming apparatus 100, the CPU 81 acquires the ID stored in the memory 15 of the fixing device 9, and acquires the corresponding demounted time information from the RAM 82.

In the of this embodiment, the discriminating portion showing the ID of the fixing device 9 is not limited to the memory 15. For example, the discriminating portion may also be resistors showing different resistance values in order to indicate the discrimination information. In this case, the image forming apparatus 100 includes a means for detecting the resistance value shown by the resistor as the discriminating portion of the fixing device 9 mounted in the image forming apparatus 100. For example, the discriminating portion may also be a DIP switch in which on-state positions of switches are different every fixing device in order to show the discrimination information.

Also in the constitution of this embodiment, it is possible obtain an effect such that a deterioration in image quality of a product due to the dust deposited on the fixing roller 40 of the fixing device 9 taken out from the image forming apparatus 100 and stored outside the image forming apparatus 100 is suppressed. Further, even the fixing device once taken out from the image forming apparatus 100, the cleaning process is not executed as regards the fixing device 9having a low possibility of deposition of the dust on the fixing roller 40, and therefore, it is possible to suppress electric power consumption with the cleaning process.

### Embodiment 8

In the above-described Embodiments 1 to 7, image forming apparatus 100 has the constitution in which only one fixing portion (fixing device 9) is provided, but a constitution in which a single image forming apparatus 100 includes a plurality of fixing portions may also be employed. Also in this case, each of the fixing portions has the same constitution as the fixing portion described in Embodiment 1.

### Embodiment 9

In the above-described Embodiments 1 to 8, the image forming apparatus 100 was described using the color image forming apparatus including the image forming portions Pa, Pb, Pc, Pd for forming the toner images of yellow, magenta, cyan, black as an example, but may also be a monochromatic image forming apparatus. For example, a monochromatic image forming apparatus for forming a black toner image may also be used.

### Embodiment 10

In the above-described Embodiments 1 to 9, the image forming apparatus 100 had the constitution of the intermediary transfer type including the intermediary transfer member 20, but may also have a constitution of a direct transfer type. That is, the image forming apparatus 100 does not include the intermediary transfer member 20, but the image forming portions Pa, Pb, Pc, Pd directly transfer the respective color toner images onto the recording material P. As a result, the toner image (unfixed) is formed on the recording material P.

### Embodiment 11

In the above-described Embodiments 1 to 10, the fixing device 9 had the constitution in which the fixing roller 40 and the pressing roller 41 form the nip N, but a constitution in which a fixing belt (rotatable member) and/or a pressing belt may also be employed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-252519 filed on Dec. 24, 2015, which is hereby incorporated by reference herein in its entirety.

What is claimed is:

1. An image forming apparatus comprising:
an image forming portion configured to form an image on a recording material;
a fixing portion provided detachably mountable to a main assembly of said image forming apparatus and configured to fix, on the recording material, the image formed by said image forming portion, wherein said fixing portion includes a rotatable member contacting a surface of recording material, on which the image is formed, when the image is fixed, and includes a storing portion configured to store information on a time at which said fixing portion is demounted from the main assembly;
an acquiring portion configured to acquire the information stored by said storing portion depending on mounting of said fixing portion in the main assembly; and
a controller configured to control whether or not a cleaning process for removing a deposited matter on a surface of said rotatable member is executed depending on an elapsed time from the time indicated by the information acquired by said acquiring portion,
wherein when the elapsed time is not less than a predetermined time, said controller executes the cleaning process in a period from the mounting of said fixing portion in the main assembly to a start of fixing, and
when the elapsed time is less than the predetermined time, said controller does not executes the cleaning process in the period.

2. An image forming apparatus according to claim 1, further comprising a cleaning portion configured to clean the surface of said rotatable member by the CP.

3. An image forming apparatus according to claim 2, wherein said fixing portion further comprises another rotatable member configured to form a nip in cooperation with said rotatable member, and
wherein said cleaning portion is an air blowing member configured to blow air for separating, from said rotatable member, the recording material passing through the nip during execution of the fixing by said fixing portion.

4. An image forming apparatus according to claim 2, wherein said fixing portion mounted in the main assembly of said image forming apparatus further comprises, in said storing portion, a writing portion configured to write the information.

5. An image forming apparatus according to claim 1, further comprising an openable portion configured to open and close an opening for permitting demounting said fixing portion from the main assembly,
wherein said storing portion stores, as the information on the time, a time recorded depending on opening of said openable portion.

6. An image forming apparatus comprising:
an image forming portion configured to form an image on a recording material;
a fixing portion provided detachably mountable to a main assembly of said image forming apparatus and configured to fix, on the recording material, the image formed by said image forming portion, wherein said fixing portion includes a rotatable member contacting a surface of recording material, on which the image is formed, when the image is fixed, and includes a storing portion configured to store time information corresponding to a time from the main assembly;
an acquiring portion configured to acquire the time information stored by said storing portion depending on mounting of said fixing portion in the main assembly; and
a controller configured to control whether or not a cleaning process for removing a deposited matter on a surface of said rotatable member is executed depending on an elapsed time from the time indicated by the time information acquired by said acquiring portion,
wherein when the elapsed time is not less than a predetermined time, said controller executes the cleaning process in a period from the mounting of said fixing portion in the main assembly to a start of fixing, and
when the elapsed time is less than the predetermined time, said controller does not executes the cleaning process in the period.

7. An image forming apparatus according to claim 6, further comprising a cleaning portion configured to clean the surface of said rotatable member by the CP.

8. An image forming apparatus according to claim 7, wherein said fixing portion further comprises another rotatable member configured to form a nip in cooperation with said rotatable member, and
wherein said cleaning portion is an air blowing member configured to blow air for separating, from said rotatable member, the recording material passing through the nip during execution of the fixing by said fixing portion.

9. An image forming apparatus according to claim 6, wherein said fixing portion mounted in the main assembly of said image forming apparatus further comprises, in said storing portion, a writing portion configured to write the time information.

10. An image forming apparatus comprising:
an image forming portion configured to form an image on a recording material;
a fixing portion provided detachably mountable to a main assembly of said image forming apparatus and configured to fix, on the recording material, the image formed by said image forming portion, wherein said fixing portion includes a rotatable member contacting a surface of recording material, on which the image is formed, when the image is fixed, and includes a discriminating portion indicating discrimination information for discriminating between said fixing portion and another fixing portion mountable in the main assembly so as to be replaceable with said fixing portion;
a storing portion configured to store time information on a time at which said fixing portion is demounted from the main assembly corresponding to the discrimination information of the fixing portion;
an acquiring portion configured to acquire, from said discriminating portion, the discrimination information of said fixing portion mounted in the main assembly, depending on mounting of said fixing portion in the main assembly; and
a controller configured to control whether or not a cleaning process for removing a deposited matter on a surface of said rotatable member is executed depending on an elapsed time from the time indicated by the time information stored in said storing portion in association with the discrimination information acquired by said acquiring portion,
wherein when the elapsed time is not less than a predetermined time, said controller executes the cleaning process in a period from the mounting of said fixing portion in the main assembly to a start of fixing, and
when the elapsed time is less than the predetermined time, said controller does not executes the cleaning process in the period.

11. An image forming apparatus according to claim 10, further comprising a cleaning portion configured to clean the surface of said rotatable member by the CP.

12. An image forming apparatus according to claim 11, wherein said fixing portion further comprises another rotatable member configured to form a nip in cooperation with said rotatable member, and
wherein said cleaning portion is an air blowing member configured to blow air for separating, from said rotatable member, the recording material passing through the nip during execution of the fixing by said fixing portion.
